(19) United States
(12) Patent Application Publication
(10) Pub. No.: US 2021/0084569 A1
(43) Pub. Date: Mar. 18, 2021

(54) METHOD FOR UPDATING LADN INFORMATION IN WIRELESS COMMUNICATION SYSTEM AND DEVICE THEREFOR

(71) Applicant: LG ELECTRONICS INC., Seoul (KR)

(72) Inventors: Hyunsook KIM, Seoul (KR); Laeyoung KIM, Seoul (KR); Jinsook RYU, Seoul (KR); Myungjune YOUN, Seoul (KR)

(21) Appl. No.: 17/054,683

(22) PCT Filed: Jan. 30, 2019
(86) PCT No.: PCT/KR2019/001298

§ 371 Date: Nov. 11, 2020

(30) Foreign Application Priority Data
May 11, 2018 (KR) 10-2018-0054302

(51) Int. Cl. H04W 48/08

(52) U.S. Cl. CPC H04W 48/08

(57) ABSTRACT

A method for updating local access data network (LADN) information by an access and mobility management function (AMF) in a wireless communication system is disclosed. The method includes, based on an update occurring in the LADN information for a LADN service configured for a user equipment (UE), receiving the updated LADN information, the updated LADN information including information on an updated LADN service area and information on an updated LADN data network name (DNN); and transmitting the updated LADN information to the UE, wherein the AMF is determined based on the updated LADN service area.

### TECHNICAL FIELD

The present disclosure relates to a wireless communication system, and more particularly to a method for updating LADN service information of a user equipment (UE) and a device therefor.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive multiple input multiple output (MIMO), in-band full duplex, non-orthogonal multiple access (NOMA), supporting a super-wide band, and device networking, have been researched.

In particular, for devices whose lifespan is greatly affected by power consumption, various technologies for reducing the power consumption are being recently studied actively.

### DISCLOSURE

### Technical Problem

According to a related art, it is assumed that LADN information has been previously configured to an AMF providing LADN service. That is, an operator can (previously) configure/update information on the LADN service to the AMF through an OAM method. However, such a configuration/update method is not suitable for a scenario providing a large number of LADN services, particularly, a scenario in which services are dynamically configured or changed. In particular, because the OAM method of the operator has a high probability of an unpredictable failure, configuration of the LADN information needs to be changed according to pre-coordinated and pre-defined mechanisms.

Accordingly, an object of the present disclosure is to provide a method for efficiently/flexibly updating LADN information of a user equipment.

Embodiments for a method and a device for solving the above-described technical problem are described. The technical problems to be solved by the present disclosure are not limited by the above-mentioned technical problems, and other technical problems which are not mentioned above can be clearly understood from the following description by those skilled in the art to which the present disclosure pertains.

### Technical Solution

In one aspect, there is provided a method for updating local access data network (LADN) information by an access and mobility management function (AMF) in a wireless communication system, the method comprising, based on an update occurring in the LADN information for a LADN service configured for a user equipment (UE), receiving the updated LADN information, the updated LADN information including information on an updated LADN service area and information on an updated LADN data network name (DNN); and transmitting the updated LADN information to the UE, wherein the AMF is determined based on the updated LADN service area.

The updated LADN information may be transmitted to the UE through a registration procedure or a UE configuration update procedure.

As the AMF, an AMF located in the updated LADN service area may be selected.

The AMF may be selected by a policy control function (PCF), and the updated LADN information may be received from the PCF.

The PCF may be a network node that receives, from a network exposure function (NEF) and/or a data network (DN)/application function (AF), information on a provision area scope of the LADN service and/or information on a provision time of the LADN service.

The AMF may be selected considering the LADN service provision area scope and/or a serving AMF of the UE, in addition to the updated LADN service area information.

Based on the LADN service provision area scope being additionally considered, as the AMF, an AMF located in the updated LADN service area and the LADN service provision area scope may be selected.

Based on a serving AMF of the UE being additionally considered, as the AMF, the serving AMF and at least one AMF logically associated with the serving AMF may be selected.

The UE may establish a packet data unit (PDU) session based on the updated LADN information, and may be provided with the LADN service via the established PDU session.

The method may further comprise receiving, from a session management function (SMF), information informing a release or a deactivation of the established PDU session to transmit the information to the UE.

The information informing the release or the deactivation of the established PDU session may be transmitted to the UE via a non-access stratum (NAS) message or a radio resource control (RRC) message.

The information informing the release or the deactivation of the established PDU session may include cause information for the release or the deactivation of the established PDU session.

Transmitting the updated LADN information to the UE may be performed based on a determination that the received updated LADN information is compared with and different from LADN information that has been already stored for the UE.

In another aspect, there is provided an access and mobility management function (AMF) updating local access data network (LADN) information in a wireless communication system, the AMF comprising a communication module configured to transmit and receive a signal; and a processor configured to control the communication module, wherein the processor is configured to, based on an update occurring in the LADN information for a LADN service configured for a user equipment (UE), receive the updated LADN information from a network node, the updated LADN information including information on an updated LADN service area and information on an updated LADN data network name (DNN); and transmit the updated LADN information to the UE, wherein the AMF is determined based on the updated LADN service area.

In another aspect, there is provided a user equipment (UE) updating local access data network (LADN) information in a wireless communication system, the UE comprising a communication module configured to transmit and receive a signal; and a processor configured to control the communication module, wherein the processor is configured to receive updated LADN information from an access and mobility management function (AMF), the updated LADN information including information on an updated LADN service area and information on an updated LADN data network name (DNN); and establish a packet data unit (PDU) session based on the updated LADN information to receive a LADN service for the UE, wherein the AMF is determined based on the updated LADN service area.

### Advantageous Effects

According to embodiments of the present disclosure, since LADN service information of the UE is flexibly/dynamically updated in real time, there occurs an effect of more efficiently/accurately providing the LADN service to the UE/user.

Effects which can be obtained in the present disclosure are not limited to the aforementioned effects, and other unmentioned effects will be clearly understood by those skilled in the art from the following description.

### Description of Drawings

The accompanying drawings, which are included to provide a further understanding of the present disclosure and constitute a part of the detailed description, illustrate embodiments of the present disclosure and together with the description serve to explain the principle of the present disclosure.

FIG. 1 illustrates a 5G system architecture using reference point representation.

FIG. 2 illustrates a radio protocol stack to which the present disclosure is applicable.

FIG. 3 illustrates a method for providing LADN information according to an embodiment of the present disclosure.

FIG. 4 illustrates an operation method of an AMF for reporting whether an UE is located in an LADN service area in accordance with an embodiment of the present disclosure.

FIG. 5 illustrates an operation method of an AMF determining whether an UE is located in an area of interest in accordance with an embodiment of the present disclosure.

FIG. 6 illustrates a problem scenario to which the present disclosure is applicable.

FIG. 7 illustrates a problem scenario to which the present disclosure is applicable.

FIG. 8 is a flow chart illustrating a dynamic/flexible updating method of LADN information according to an embodiment of the present disclosure.

FIG. 9 illustrates an interaction between a UE and a SMF when the SMF determines releasing a LADN PDU session.

FIG. 10 illustrates an interaction between a UE and a SMF when the SMF determines deactivating a LADN PDU session.

FIG. 11 is a flow chart illustrating an LADN information updating method of an AMF according to an embodiment of the present disclosure.

FIG. 12 is a block diagram of an AMF updating LADN information according to an embodiment of the present disclosure.

FIG. 13 is a flow chart illustrating an LADN information updating method of a UE according to an embodiment of the present disclosure.

FIG. 14 is a block diagram of a UE updating LADN information according to an embodiment of the present disclosure.

FIG. 15 illustrates a block configuration diagram of a communication device according to an embodiment of the present disclosure.

FIG. 16 illustrates a block configuration diagram of a communication device according to an embodiment of the present disclosure.

### MODE FOR INVENTION

In what follows, preferred embodiments according to the present disclosure will be described in detail with reference to appended drawings. The detailed descriptions provided below together with appended drawings are intended only to explain illustrative embodiments of the present disclosure, which should not be regarded as the sole embodiments of the present disclosure. The detailed descriptions below include specific information to provide complete understanding of the present disclosure. However, those skilled in the art will be able to comprehend that the present disclosure can be embodied without the specific information.

For some cases, to avoid obscuring the technical principles of the present disclosure, structures and devices well-known to the public can be omitted or can be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by an upper node of the base station depending on situations. In other words, it is apparent that in a network consisting of a plurality of network nodes including a base station, various operations performed for communication with a UE can be performed by the base station or by network nodes other than the base station. The term Base Station (BS) can be replaced with a fixed station, Node B, evolved-NodeB (eNB), Base Transceiver System (BTS), or Access Point (AP). Also, a terminal can be fixed or mobile; and the term can be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter can be part of the base station, and a receiver can be part of the terminal. Similarly, in uplink transmission, a transmitter can be part of the terminal, and a receiver can be part of the base station.

Specific terms used in the following descriptions are introduced to help understanding the present disclosure, and the specific terms can be used in different ways as long as it does not leave the technical scope of the present disclosure.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. The TDMA may be implemented by radio technology such as Global System for Mobile communications (GSM)/General Packet Radio Service(GPRS)/Enhanced Data Rates for GSM Evolution (EDGE). The OFDMA may be implemented as radio technology such as IEEE 802.11(Wi-Fi), IEEE 802.16 (WiMAX), IEEE 802-20, E-UTRA (Evolved UTRA), and the like. The UTRA is a part of a universal mobile telecommunication system (UMTS). 3rd generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

Embodiments of the present disclosure can be supported by standard documents disclosed in at least one of wireless access systems including the IEEE 802, 3GPP, and 3GPP2 specifications. In other words, among the embodiments of the present disclosure, those steps or parts omitted for the purpose of clearly describing technical principles of the present disclosure can be supported by the documents above. Also, all of the terms disclosed in this document can be explained with reference to the standard documents.

3GPP LTE/LTE-A/NR is primarily described for clear description, but technical features of the present disclosure are not limited thereto.

Terms used in the present disclosure are defined as follows.

Universal Mobile Telecommunication System (UMTS): the 3rd generation mobile communication technology based on global system for mobile communication (GSM) developed by the 3GPP.

Evolved Packet System (EPS): a network system consisting of an evolved packet core (EPC), that is an IP based packet switched core network, and an access network such as LTE and UTRAN. The EPS is a network of an evolved version of a universal mobile telecommunications system (UMTS).

NodeB: a base station of a UMTS network. It is installed outdoor, and its coverage has a scale of a macro cell.

eNodeB: a base station of an EPS network. It is installed outdoor, and its coverage has a scale of a macro cell.

Home NodeB: it is installed indoors as a base station of the UMTS network, and its coverage has a scale of a macro cell.

Home eNodeB: it is installed indoors as a base station of the EPS network, and its coverage has a scale of a macro cell.

User Equipment (UE): the UE can be called a terminal, a mobile equipment (ME), a mobile station (MS), etc. The UE can be a portable device such as a notebook computer, a cellular phone, a personal digital assistant (PDA), a smart phone, and a multimedia device, or a fixed device such as a personal computer (PC) and a vehicle-mounted device. The term of UE may refer to an MTC UE in the description related to MTC.

Machine Type Communication (MTC): communication performed by machines without human intervention. It may be called Machine-to-Machine (M2M) communication.

MTC terminal (MTC UE or MTC device or MRT apparatus): a terminal (e.g., a vending machine, meter, etc.) having a communication function (e.g., communication with an

MTC server over PLMN) over a mobile communication network and performing a MTC function.

Radio Access Network (RAN): a unit including a Node B and a radio network controller (RNC) controlling the Node B in the 3GPP network. The RAN exists at a UE end and provides a connection to a core network.

Home Location Register (HLR)/Home Subscriber Server (HSS): a database containing subscriber information within the 3GPP network. The HSS can perform functions such as configuration storage, identity management, user state storage, etc.

Public Land Mobile Network (PLMN): a network configured for the purpose of providing mobile communication services to individuals. The PLMN can be configured for each operator.

Non-Access Stratum (NAS): a functional layer for exchanging signalling and a traffic message between a UE and a core network at the UMTS and EPS protocol stacks. The NAS mainly functions to support mobility of the UE and support a session management procedure for establishing and maintaining an IP connection between the UE and PDN GW.

Service Capability Exposure Function (SCEF): an entity within the 3GPP architecture for service capability exposure that provides a means to safely expose the services and capabilities provided by 3GPP network interfaces.

Mobility Management Entity (MME): a network node in the EPS network which performs mobility management and session management functions.

Packet Data Network Gateway (PDN-GW): a network node in the EPS network which performs UE IP address allocation, packet screening and filtering, and charging data collection functions.

Serving GW (Serving Gateway): a network node in the EPS network which performs functions such as mobility anchor, packet routing, idle mode packet buffering, and triggering paging for the ME of MME.

Policy and Charging Rule Function (PCRF): a node in the EPS network which performs policy decision to dynamically apply differentiated QoS and billing policies for each service flow.

Packet Data Network (PDN): a network in which a server (e.g., MMS server, WAP server, etc.) supporting a specific service is located.

PDN connection: a connection from the UE to the PDN, i.e., the association (connection) between the UE represented by the IP address and the PDN represented by the APN.

Hereinafter, the present disclosure is described based on the terms defined as above.

### 5G System Architecture to which the Present Disclosure is Applicable

A 5G system is an Advanced Technology from 4G LTE Mobile Communication technology and supports a new radio access technology (RAT), extended long term evolution (eLTE) as an extended technology of LTE, non-3GPP access (e.g., wireless local area network (WLAN) access), etc. through the evolution of an existing mobile communication network structure or a clean-state structure.

The 5G system is defined based on a service, and an interaction between network functions (NFs) in architecture for the 5G system can be represented in two ways as follows.

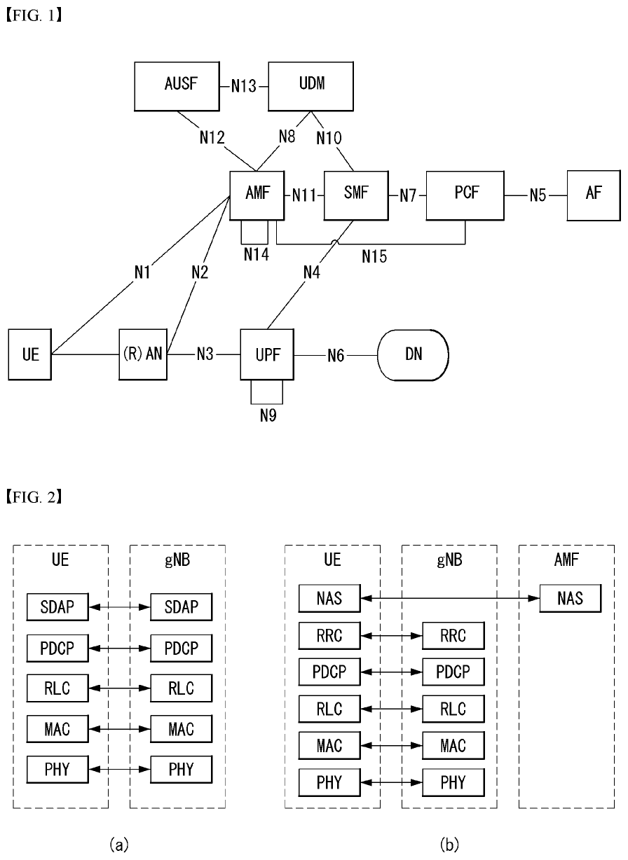

Reference point representation (FIG. 1): depicts an interaction between NF services in NFs described by a point-to-point reference point (e.g., N11) between two NFs (e.g., AMF and SMF).

Service-based representation (FIG. 2): network functions (e.g., AMF) within a control plane (CP) allow other authenticated network functions to access their services. The representation also includes a point-to-point reference point, if necessary.

FIG. 1 illustrates a 5G system architecture using reference point representation.

Referring to FIG. 1, the 5G system architecture may include various components (i.e., network functions (NFs)). FIG. 1 illustrates some of the various components, for example, an authentication server function (AUSF), a (core) access and mobility management function (AMF), a session management function (SMF), a policy control function (PCF), an application function (AF), a unified data management (UDM), a data network (DN), a user plane function (UPF), a (radio) access network ((R)AN), and a user equipment (UE).

The respective NFs support the following functions.

The AUSF stores data for the authentication of the UE.

The AMF provides a function for the connection and mobility management for each UE, and one AMF can be basically connected to one UE.

More specifically, the AMF supports functions of inter-CN node signaling for mobility between 3GPP access networks, termination of RAN CP interface (i.e., N2 interface), termination N1 of NAS signaling, NAS signaling security (NAS ciphering and integrity protection), AS security control, registration management (registration area management), connection management, idle mode UE reachability (including control and execution of paging retransmission), mobility management control (subscription and policy), support of intra-system mobility and inter-system mobility, support of network slicing, SMF selection, lawful intercept (for an interface to AMF event and L1 system), providing the delivery of a session management (SM) message between UE and SMF, transparent proxy for routing the SM message, access authentication, access authorization including roaming authority check, providing the delivery of a short message service (SMS) message between UE and SMS function (SMSF), security anchor function (SEA) and/or security context management (SCM), and the like.

Some or all functions of the AMF can be supported in a single instance of one AMF.

The DN means, for example, operator services, internet access, or 3rd party service. The DN transmits a downlink protocol data unit (PDU) to the UPF or receives the PDU transmitted from the UE from the UPF.

The PCF receives information about packet flow from an application server and provides functions of determining policies such as mobility management and session management. More specifically, the PCF supports functions of supporting a unified policy framework for controlling a network operation, providing a policy rule so that CP function(s) (e.g., AMF, SMF, etc.) can enforce the policy rule, and implementing a front end for accessing related subscription information for policy decision in a user data repository (UDR).

The SMF provides a session management function. If the UE has a plurality of sessions, the sessions can be respectively managed by different SMFs.

More specifically, the SMF supports functions of session management (e.g., session establishment, modification, and release, including tunnel maintenance between the UPF and the AN node), UE IP address allocation and management (including optional authentication), selection and control of UP function, configuring traffic steering at UPF to route traffic to proper destination, termination of interfaces toward policy control functions, enforcement of control part of a policy and QoS, lawful intercept (for an interface to SM event and L1 system), termination of SM part of a NAS message, downlink data notification, an initiator of AN specific SM information (sent to AN via the AMF over N2), SSC mode decision of the session, a roaming function, and the like.

Some or all functions of the SMF can be supported within a single instance of one SMF.

The UDM stores subscription data of user, policy data, etc. The UDM includes two parts, i.e., application front end (FE) and user data repository (UDR).

The FE includes UDM FE taking charge of location management, subscription management, processing of credential, etc. and PCF taking charge of policy control. The UDR stores data required for functions provided by the UDM-FE and a policy profile required by the PCF. Data stored in the UDR includes user subscription data including subscription identifier, security credential, access and mobility related subscription data, and session related subscription data and policy data. The UDM-FE accesses subscription information stored in the UDR and supports functions of authentication credential processing, user identification handling, access authentication, registration/mobility management, subscription management, SMS management, and the like.

The UPF transmits the downlink PDU received from the DN to the UE via the (R)AN and transmits the uplink PDU received from the UE to the DN via the (R)AN.

More specifically, the UPF supports functions of anchor point for intra/inter RAT mobility, external PDU session point of interconnect to data network (DN), packet routing and forwarding, packet inspection and user plane part of policy rule enforcement, lawful intercept, reporting of traffic usage, uplink classifier to support routing traffic flow to data network, branching point to support multi-homed PDU session, QoS handling (e.g., packet filtering, gating, uplink/downlink rate enforcement) for user plane, uplink traffic verification (service data flow (SDF) mapping between SDF and QoS flow), transport level packet marking in the uplink and downlink, downlink packet buffering and downlink data notification triggering, and the like. Some or all of the functions of the UPF can be supported in a single instance of one UPF.

AF interacts with 3GPP core network to provide services (e.g., support functions of an application influence on traffic routing, network capability exposure access, interaction with policy framework for policy control, and the like).

(R)AN collectively refers to a new radio access network supporting both evolved E-UTRA, that is an evolved version of 4G radio access technology, and a new radio (NR) access technology (e.g., gNB).

In the 5G system, a network node radio that is responsible for transmitting and receiving radio signals with the UE is gNB, and serves as the eNB in the EPS.

The gNB supports functions of radio resource management function (i.e., radio bearer control, radio admission control, connection mobility control, dynamic allocation of resources to the UE in uplink/downlink (scheduling)), Internet protocol (IP) header compression, encryption of user data stream and integrity protection, selection of AMF upon attachment of the UE if routing to the AMF is not determined from information provided to the UE, routing of user plane data to UPF(s), routing of control plane information to ANF, connection setup and release, scheduling and transmission of a paging message (generated from the AMF), scheduling and transmission of system broadcast information (generated from the AMF or operating and maintenance (O&M)), measurement and measurement reporting configuration for mobility and scheduling, transport level packet marking in uplink, session management, support of network slicing, QoS flow management and mapping to data radio bearer, support of a UE in an inactive mode, NAS message distribution function, NAS node selection function, radio access network sharing, dual connectivity, tight interworking between NR and E-UTRA, and the like.

The UE means a user equipment. The user equipment may be referred to as a term such as a terminal, a mobile equipment (ME), and a mobile station (MS). The user equipment may be a portable device such as a notebook computer, a cellular phone, a personal digital assistant (PDA), a smart phone, and a multimedia device, or a non-portable device such as a personal computer (PC) and a vehicle-mounted device.

Although unstructured data storage network function (UDSF), structured data storage network function (SDSF), network exposure function (NEF), and NF repository function (NRF) are not shown in this figure for clarity of explanation, all the NFs shown in this figure can perform interaction with the UDSF, the NEF and the NRF, if necessary.

The NEF provides a means to securely expose services and capabilities provided by 3GPP network functions, for example, 3rd party, internal exposure/re-exposure, application function, and edge computing. The NEF receives information from other network function(s) (based on exposed capabilities of other network function(s)). The NEF can store the received information as structured data using a standardized interface to a data storage network function. The stored information can be re-exposed by the NEF to other network functions and other application functions and can be used for other purposes such as analytics.

The NRF supports a service discovery function. The NRF receives NF Discovery Request from NF instance and provides information of the discovered NF instance to the NF instance. The NRF also maintains available NF instances and their supported services.

The SDSF is structured data by any NEF and is a selective function to support a storage and retrieval function of information.

The UDSF is unstructured data by any NF and is a selective function to support a storage and retrieval function of information.

In the 5G system, a node, that is responsible for transmitting and receiving radio signals with the UE, is gNB, and serves as the eNB of the EPS. If the UE is simultaneously connected to 3GPP access and non-3GPP access, the UE receives services via one AMF as illustrated in FIG. 1. FIG. 1 illustrates that the UE is connected to one same UPF when the UE is connected to the non-3GPP access and when the UE is connected to the 3GPP access, but the present disclosure is not limited thereto. For example, the UE may be connected to a plurality of different UPFs.

However, if the UE selects N3IWK (also referred to as ‘non-3GPP interworking function (N3IWF)’) in HPLMN in a roaming scenario and is connected to the non-3GPP access, the AMF managing the 3GPP access may be located in VPLMN and the AMF managing the non-3GPP access may be located in the HPLMN.

A non-3GPP access network is connected to the 5G core network via N3IWK/N3IWF. The N3IWK/N3IWF interfaces 5G core network control plane function and user plane function via the N2 and N3 interfaces, respectively.

A representative example of the non-3GPP access mentioned in the present disclosure may be WLAN access.

FIG. 1 illustrates a reference model where the UE accesses one DN using one PDU session for convenience of explanation, but the present disclosure is not limited thereto.

The UE can simultaneously access two (i.e., local and central) data networks using multiple PDU sessions. In this instance, two SMFs may be selected for different PDU sessions. Each SMF may have a capability capable of controlling both local UPF and central UPF within the PDU session. The SMF may be independently activated for each PDU session.

Further, the UE can simultaneously access two (i.e., local and central) data networks provided within a single PDU session.

In the 3GPP system, a conceptual link connecting between the NFs in the 5G system is defined as a reference point. The following illustrates reference points included in the 5G system architecture as represented in this figure.

N1: Reference point between the UE and the AMF

N2: Reference point between the (R)AN and the AMF

N3: Reference point between the (R)AN and the UPF

N4: Reference point between the SMF and the UPF

N5: Reference point between the PCF and the AF

N6: Reference point between the UPF and the data network

N7: Reference point between the SMF and the PCF

N24: Reference point between the PCF in the visited network and the PCF in the home network

N8: Reference point between the UDM and the AMF

N9: Reference point between two core UPFs

N10: Reference point between the UDM and the SMF

N11: Reference point between the AMF and the SMF

N12: Reference point between the AMF and the AUSF

N13: Reference point between UDM and Authentication Server function (AUSF)

N14: Reference point between two AMFs

N15: Reference point between the PCF and the AMF in case of non-roaming scenario, reference point between PCF in the visited network and AMF in case of roaming scenario

N16: Reference point between two SMFs (reference point between the SMF in the visited network and the SMF in the home network in case of roaming scenario)

N17: Reference point between AMF and EIR

N18: Reference point between any NF and UDSF

N19: Reference point between NEF and SDSF

### Radio Protocol Architecture

FIG. 2 illustrates a radio protocol stack in a wireless communication system to which the present disclosure is applicable. More specifically, FIG. 2(a) illustrates a radio interface user plane protocol stack between a UE and gNB, and FIG. 2(b) illustrates a radio interface control plane protocol stack between the UE and the gNB.

The control plane means a path through which control messages used for a UE and a network to manage calls are transmitted. The user plane means a path through which data generated in an application layer, for example, voice data, Internet packet data, and so on are transmitted.

Referring to FIG. 2(a), the user plane protocol stack may be divided into Layer 1 (i.e., physical (PHY) layer) and Layer 2.

Referring to FIG. 2(b), the control plane protocol stack may be divided into Layer 1 (i.e., PHY layer), Layer 2, Layer 3 (i.e., radio resource control (RRC) layer), and a Non-Access Stratum (NAS) layer.

The Layer 2 is divided into a Medium Access Control (MAC) sublayer, a Radio Link Control (RLC) sublayer, a Packet Data Convergence Protocol (PDCP) sublayer, and a Service Data Adaptation Protocol (SDAP) sublayer (in case of the user plane).

A radio bearer is classified into two groups: data radio bearer (DRB) for user plane data and signaling radio bearer (SRB) for control plane data.

Each layer of the control plane and the user plane of the radio protocol is described below.

1) The Layer 1, i.e., the PHY layer, provides information transfer service to an upper layer by using a physical channel. The PHY layer is connected to the MAC sublayer located at an upper level through a transport channel, and data are transmitted between the MAC sublayer and the PHY layer through the transport channel. The transport channel is classified according to how and which feature data is transmitted via a radio interface. And, data is transmitted between different PHY layers, between a PHY layer of a transmitter and a PHY layer of a receiver, through a physical channel.

2) The MAC sublayer performs mapping between a logical channel and a transport channel; multiplexing/demultiplexing of MAC Service Data Unit (SDU) belonging to one or different logical channel(s) to/from a transport block (TB) delivered to/from the PHY layer through a transport channel; scheduling information reporting; error correction through hybrid automatic repeat request (HARQ); priority handling between UEs using dynamic scheduling; priority handling between logical channels of one UE using logical channel priority; and padding.

Different kinds of data deliver a service provided by the MAC sublayer. Each logical channel type defines what type of information is delivered.

The logical channel is classified into two groups: a Control Channel and a Traffic Channel.

i) The Control Channel is used to deliver only control plane information and is as follows.

Broadcast Control Channel (BCCH): a downlink channel for broadcasting system control information.

Paging Control Channel (PCCH): a downlink channel that delivers paging information and system information change notification.

Common Control Channel (CCCH): a channel for transmitting control information between a UE and a network. This channel is used for UEs having no RRC connection with the network.

Dedicated Control Channel (DCCH): a point-to-point bi-directional channel for transmitting dedicated control information between the UE and the network. This channel is used by the UE having an RRC connection.

ii) The Traffic Channel is used to use only user plane information.

Dedicated Traffic Channel (DTCH): a point-to-point channel, dedicated to a single UE, for delivering user information. The DTCH may exist in both uplink and downlink.

In the downlink, connection between the logical channel and the transport channel is as follows.

The BCCH may be mapped to BCH. The BCCH may be mapped to DL-SCH. The PCCH may be mapped to PCH. The CCCH may be mapped to the DL-SCH. The DCCH may be mapped to the DL-SCH. The DTCH may be mapped to the DL-SCH.

In the uplink, connection between the logical channel and the transport channel is as follows. The CCCH may be mapped to UL-SCH. The DCCH may be mapped to the UL-SCH. The DTCH may be mapped to the UL-SCH.

3) The RLC sublayer supports three transmission modes: a Transparent Mode (TM), an Unacknowledged Mode (UM), and an Acknowledged Mode (AM).

The RLC configuration may be applied for each logical channel. In case of SRB, the TM or the AM is used. On the other hand, in case of DRB, the UM the AM is used.

The RLC sublayer performs the delivery of the upper layer PDU; sequence numbering independent of PDCP; error correction through automatic repeat request (ARQ); segmentation and re-segmentation; reassembly of SDU; RLC SDU discard; and RLC re-establishment.

4) A PDCP sublayer for the user plane performs Sequence Numbering; header compression and decompression (Robust Header Compression (RoHC) only); delivery of user data; reordering and duplicate detection (if the delivery to a layer above the PDCP is required); PDCP PDU routing (in case of a split bearer); re-transmission of PDCP SDU; ciphering and deciphering; PDCP SDU discard; PDCP re-establishment and data recovery for RLC AM; and duplication of PDCP PDU.

The PDCP sublayer for the control plane additionally performs Sequence Numbering; ciphering, deciphering and integrity protection; delivery of control plane data; duplicate detection; and duplication of PDCP PDU.

When duplication is configured for a radio bearer by RRC, an additional RLC entity and an additional logical channel are added to the radio bearer to control the duplicated PDCP PDU(s). The duplication at PDCP includes transmitting the same PDCP PDUs twice. Once it is transmitted to the original RLC entity, and a second time it is transmitted to the additional RLC entity. In this instance, the original PDCP PDU and the corresponding duplicate are not transmitted to the same transport block. Two different logical channels may belong to the same MAC entity (in case of CA) or different MAC entities (in case of DC). In the former case, logical channel mapping restriction is used to ensure that the original PDCP PDU and the corresponding duplicate are not transmitted to the same transport block.

5) The SDAP sublayer performs i) mapping between QoS flow and data radio bearer, and ii) QoS flow identification (ID) marking in downlink and uplink packet.

A single protocol entity of SDAP is configured for each individual PDU session, but exceptionally, in case of dual Connectivity (DC), two SDAP entities can be configured.

6) An RRC sublayer performs broadcast of system information related to Access Stratum (AS) and Non-Access Stratum (NAS); paging initiated by 5GC or NG-RAN; establishment, maintenance and release of RRC connection between UE and NG-RAN (additionally including modification and release of carrier aggregation and also additionally including modification and release of Dual Connectivity between E-UTRAN and NR or in NR); security function including key management; establishment, configuration, maintenance and release of SRB(s) and DRB(s); delivery of handover and context; UE cell selection and re-release and control of cell selection/reselection: mobility function including inter-RAT mobility; QoS management function, UE measurement reporting and control of reporting; detection of radio link failure and recovery from radio link failure; and NAS message delivery from NAS to UE and NAS message delivery from UE to NAS.

### Method for Supporting and Indicating LADN Service

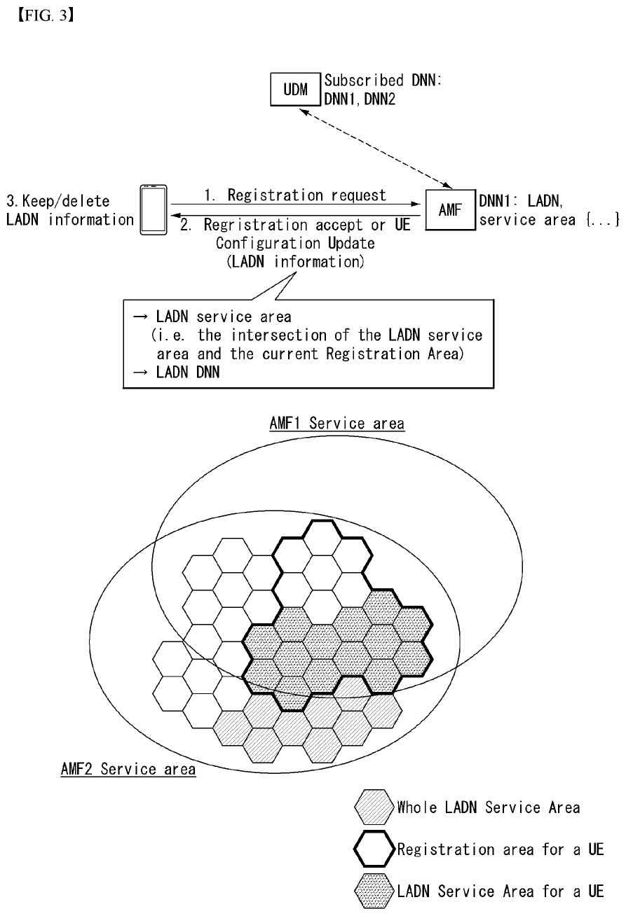

FIG. 3 illustrates a method for providing LADN information according to an embodiment of the present disclosure.

1. A UE may perform a registration procedure by sending a registration request message to the AMF. In this instance, the AMF may be an AMF configured with DNN1 to which the UE has been subscribed. DNN subscription information of the UE may be provided/configured to the AMF by the UDM.

2. If the AMF accepts a registration request of the UE, the AMF may send a registration accept message. In this instance, if the DNN1 to which the UE has been subscribed includes LADN, LADN information may be included in the registration accept message and transmitted. The LADN information may include an LADN service area (i.e., an intersection area between the LADN service area and a current registration area) in which an LADN service is provided, and/or LADN DNN.

If the LADN information is updated, the AMF may provide the LADN information to the UE through a UE configuration update message/procedure.

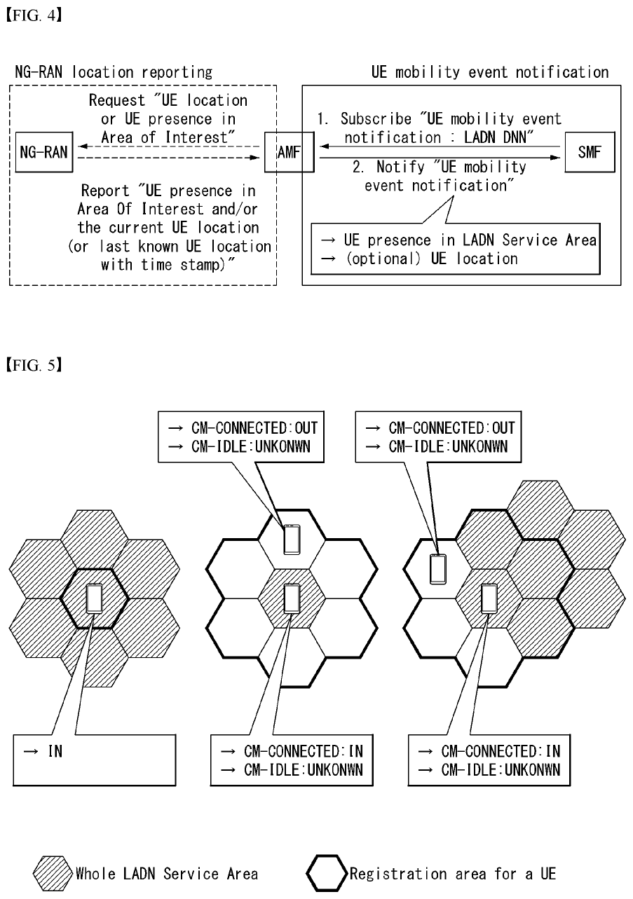

FIG. 4 illustrates an operation method of the AMF for reporting whether the UE is located in an LADN service area in accordance with an embodiment of the present disclosure.

1-2. The SMF may subscribe to a UE mobility event notification for the LADN DNN. In this case, if the UE is located in the LADN service area, the AMF may notify the SMF of “UE mobility event notification”. Optionally, the AMF may notify the SMF of detailed location information of the UE.

To this end, the AMF may inquire/request the NG-RAN a UE location or whether the UE is present in an area of interest. The NG-RAN may transmit, to the AMF, whether the UE is present in an area of interest and/or current UE location information (or last known UE location information together with a time stamp) according to the inquiry/request.

Alternatively, UE location information that has been configured/stored to the AMF without such a request may be immediately transmitted to the SMF.

FIG. 5 illustrates an operation method of the AMF determining whether the UE is located in an area of interest in accordance with an embodiment of the present disclosure.

The AMF may determine whether the UE is present in an area of interest (i.e., ‘IN’, ‘OUT’ or ‘UNKNOWN’) as given below.

1) If it is determined as ‘IN’:

if the UE is inside the area of interest, and if the UE is in a CM-CONNECTED state; or

if the UE is inside a registration area which is contained within the area of interest.

2) If it is determined as ‘OUT’:

if the UE is outside the area of interest, but is inside a registration area where the area of interest is available, and if the UE is in a CM-CONNECTED state; or

if the UE is inside a registration area where the area of interest is not available.

3) If it is determined as ‘UNKNOWN’:

if the UE is inside a registration area where the area of interest is available and the area of interest does not contain the whole registration area, and if the UE is in a CM-IDLE state.

According to the above determination result, the AMF may send Namf_EventExposure_Notify message to the SMF.

The access to a DN via a PDU session for a LADN may be available only in a specific LADN service area. A LADN service area is a set of tracking areas. The LADN is a service provided by a serving PLMN of the UE. It includes:

LADN service applies only to 3GPP accesses and does not apply in Home Routed case.

The usage of LADN DNN requires an explicit subscription to this DNN or a subscription to a wildcard DNN.

Whether a DNN corresponds to a LADN service is an attribute of a DNN.

The UE is configured to know whether the DNN is a LADN DNN.

The LADN information (i.e., LADN service area information and/or LADN DNN) is configured in the AMF on a per DN basis (i.e., for different UEs accessing the same LADN). The configured LADN service area is regardless of other factors (e.g., UE's registration area or UE subscription).

If a LADN is not available in a TA of an AMF's service area, the AMF is not required to be configured with any LADN information for the corresponding DNN.

LADN information is provided to the UE by AMF during a registration procedure or a UE configuration update procedure. For each LADN DNN configured in the AMF, the corresponding LADN service area information includes a set of tracking areas that belong to a current registration Area of the UE (i.e., an intersection of the LADN service area and the current registration area). The AMF does not create the registration area based on the availability of LADNs.

It is thus possible that the LADN service area information sent by the AMF to the UE contains only a sub-set of the full LADN service area because the LADN service area can contain TA(s) outside of the registration area of the UE or outside of the area served by the AMF.

When the UE performs a successful (re-)registration procedure, the AMF may provide to the UE, the LADN information for LADN available to the UE in the corresponding Registration Area in the Registration Accept message, based on local configuration (e.g., via operations, administration and management (OAM)) about LADN, the UE location, and UE subscription information received from the UDM about subscribed DNN(s). During a subsequent Registration Update procedure, if the network does not provide the LADN information for a DNN, the UE delete any LADN information for that DNN.

When the LADN information for the UE in the 5GC is changed, the AMF shall update LADN Information to the UE through the UE Configuration Update/Registration procedure.

Based on the LADN information within the UE, the UE takes the following actions:

a) When the UE is out of a LADN service area, the UE:

shall not request to activate UP connection of a PDU session for this LADN DNN;

shall not accept or change a PDU session for this LADN DNN;

need not release any existing PDU Session for this LADN DNN unless the UE receives an explicit SM PDU Session Release Request message from the network.

b) When the UE is in a LADN service area, the UE:

may request a PDU session establishment/modification for this LADN DNN;

may request to activate UP connection of the existing PDU session for this LADN DNN.

The SMF supporting a DNN is configured with information about whether or not this DNN is a LADN DNN. The SMF may subscribe to “UE mobility event notification” for reporting the UE presence in the area of interest by providing LADN DNN to the AMF.

Based on the notification about the UE presence in the LADN service area notified by the AMF (i.e., IN, OUT, or UNKNOWN), the SMF takes the following actions based on operator's policy:

a) When the SMF is informed that the UE is present in the LADN service area, the SMF shall:

release immediately the PDU session; or

deactivate the user plane connection for the PDU session while maintaining the PDU session and ensure that the downlink data notification is disabled, and the SMF may release the PDU session later.

b) When the SMF is informed that the LADN service area is present, the SMF shall:

ensure that the downlink data notification is enabled;

trigger a network triggered Service Request procedure for a LADN PDU session to active the UP connection when the SMF receives downlink data or data notification from the UPF.

c) When the SMF is informed that the UE presence in the LADN service area is UNKNOWN, the SMF may:

ensure that the downlink data notification is enabled;

trigger a network triggered Service Request procedure for a LADN PDU session to active the UP connection when the SMF receives downlink data or data notification from the UPF.

According to a related art, it is assumed that LADN information has been previously configured to an AMF providing LADN service. That is, the operator can (previously) configure/update information on the LADN service to the AMF through an OAM method. However, such a configuration/update method is not suitable for a scenario providing a large number of LADN services, particularly, a scenario in which services are dynamically configured or changed. In particular, because the OAM method of the operator has a high probability of an unpredictable failure, configuration of the LADN information needs to be changed according to pre-coordinated and pre-defined mechanisms.

According to this, the present disclosure proposes a flexible and dynamic configuration mechanism of LADN information.

The present disclosure is described below as individual embodiments for convenience of explanation, but is not limited thereto. The present disclosure can be implemented as a combination of one or more of embodiments described below.

First, scenarios/problems (A to C) to which the present disclosure is applicable are introduced.

A. Event held at a specific time and in a specific area (e.g., weekend flea market (5-day market)/cultural or sporting events during a specific period)

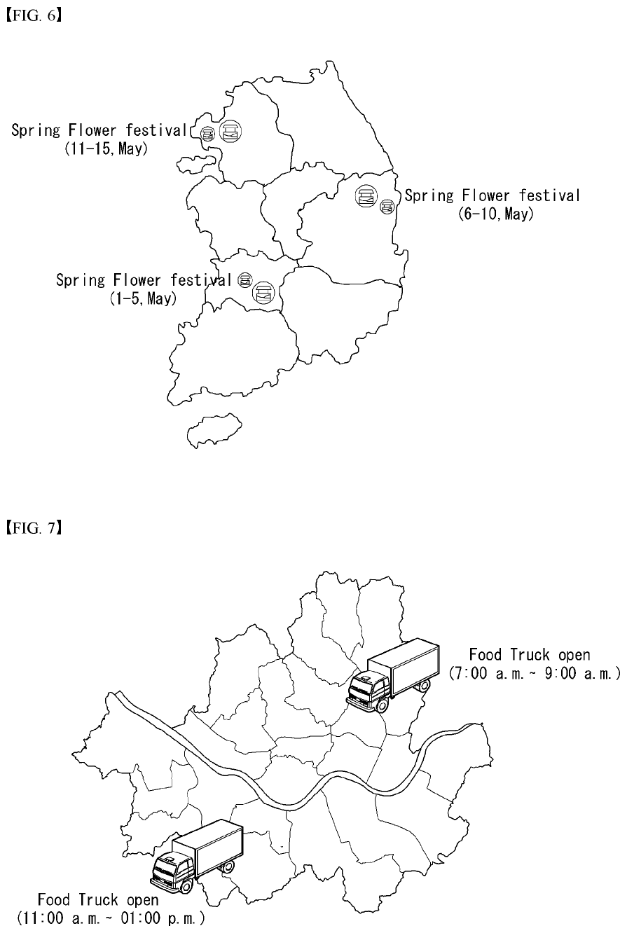

FIG. 6 illustrates a problem scenario to which the present disclosure is applicable.

In case of the related art LADN, LADN service supported in the AMF of a specific area is previously configured to the AMF. However, a scenario may be assumed, in which the serviced area can be enabled/disabled according to a specific date/period. That is, the case may occur, in which a (LADN) service area is changed and hence LADN service related information shall be updated. In preparation for such a case, the present disclosure proposes a method of using a network control mechanism not the OAM method.

B. Case where a LADN service area such as a foot truck/small goods stand is frequently changed

FIG. 7 illustrates a problem scenario to which the present disclosure is applicable.

The case in which a LADN service area is frequently changed targets a scenario in which the LADN service area is changed on a per hour basis within a day not every day/year. For example, there may be a case in which the foot truck wants to provide services in an A area during the morning hours, and services in a B area during the afternoon hours. In this case, the LADN service area may be frequently changed.

C. Area service such as cafe/restaurant: case in which stores providing (LADN) service are constantly added/changed for reasons such as opening/closing, or the stores move

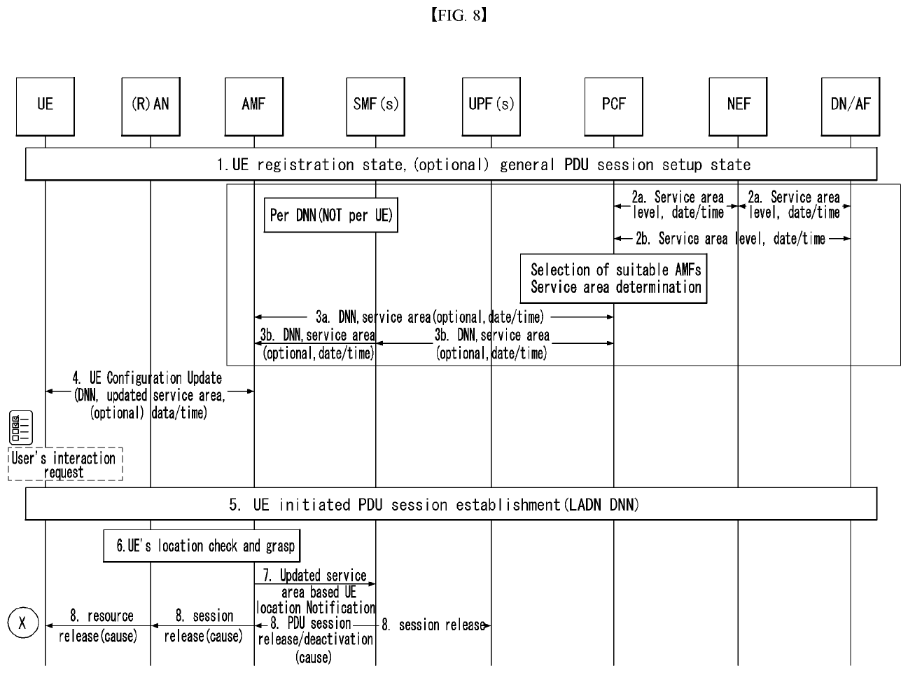

FIG. 8 is a flow chart illustrating a dynamic/flexible updating method of LADN information according to an embodiment of the present disclosure. In this flow chart, at least one step is deleted, or a new step may be inserted according to embodiments.

1. The UE may acquire LADN information (LADN DNN(s) and/or (LADN) service area information per each LADN DNN) provided by a serving network node/AMF through the attach/registration procedure with a network node. Optionally/additionally, the UE may configure a normal PDU session (e.g., IP Multimedia Services (IMS) PDU session for a voice service and/or Internet PDU session for Internet service) and may be provided with services.

2. The PCF that is a network node configuring/managing operator's policy may select the suitable AMF to which a LADN service shall be configured based on a LADN data network (DN)/application function (AF) and/or an input of NEF. Herein, the input transmitted to the PCF may include (LADN) service area level information and/or information on period/time/cycle in which the LADN service is provided (i.e., period, time and/or cycle information). The (LADN) service area level information may mean specific level information that is previously classified depending on the size of the (LADN) service area, and its examples are described in detail below.

And/or, the PCF (without the input from other network nodes) may autonomously select the AMF. For example, in the case of not 3rd party service but (LADN) service that the operator directly provides, or in the case where agreement information with 3rd party is configured to the PCF, the PCF shall be configured so that a request to adjust/change a (LADN) service scope upon the occurrence of a specific (LADN related) event can occur, if it wants to fluidly change the (LADN) service area.

A. The areas (counties) that a 3rd party service provider can request may be previously agreed between the operator and the 3rd party service provider. In this case, a network of the operator may map the serving AMF for providing services, and information for determining a service area to be provided to the UE needs to be pre-configured to the network node.

B. A scope of the adjustable (LADN) service area may be previously agreed between the operator and the 3rd party service provider at a certain level (e.g., the above-described (LADN) service area level). In this case, a level (e.g., mandatory, best effort, etc.) that requests the LADN PDU session establishment/setup from the UE may be previously agreed between the operator and the 3rd party service provider.

In this procedure/step, considering that the multiple PCFs are implemented, the NEF or the DN/AF shall send an input to all the associated PCFs, and the respective PCFs can respectively perform operations of the PCF illustrated in this figure.

An embodiment in which the suitable AMF for providing the LADN service is selected by the PCF is described in detail below.

Before describing this embodiment, it may be assumed that the PCF knows the serving AMF of the UE because all the AMFs select the PCF in an initial registration step and interwork with the PCF to receive a policy. As described below, it may also be assumed that a service agreement about a level of the area providing the LADN service has been established between the operators.

The DN/AF may request a service area for a specific LADN DNN from the PCF. In this instance, as an example below, the following levels (i.e., (LADN) service area level) for each LADN service providing area may be previously designated.

Level 1: including only a nearby area within a first distance based on where the UE is located (e.g., on a per Gu or Dong basis, etc.)

Level 2: including a large area within a second distance (greater than the first distance) based on where the UE is located (e.g., on a per City basis, etc.)

Level 3: including all the PLMN areas (e.g., a nationwide network that operators can service)

Level 4: including not only all the PLMNs but also an equivalent PLMN (EPLMN) area concluding business roaming agreement (e.g., in Europe, the countries are relatively small, so it is possible to provide services to neighboring countries with the EPLMN like the same network)

Alternatively, direct area information may be designated as the following embodiment.

Seocho-gu+Gangnam-gu;

Seoul+Busan (i.e., service areas do not necessarily have to be contiguous, and can be used if they include area information that can distinguish the network topology);

Korea; and/or

Germany+Austria, etc.

In this case, the PCF may select the suitable AMF to provide a LADN service based on one or more of the following information (A. to C.) as follows:

A. an area level of the (LADN) service requested by the DN/AF and/or a network topology mapped to the area (in this case, the AMFs included on the network topology may be selected) (related to physical configuration of the network);

B. a current serving AMF of the UE(s) that intends to provide the (LADN) service and a pool including the corresponding AMF (in this case, other AMFs included in both the serving AMF and the pool may be selected) (related to physical configuration of the network); and/or

C. information on period/time/cycle in which the (LADN) service received from the DN/AF is provided (if the (LADN) service is not provided immediately but is provided in a specific period/time/cycle, information of the current serving AMF may be meaningless.

Thus, this information may be used for whether to consider the current serving AMF information (i.e., whether to select the serving AMF)).

3. The PCF may transmit LADN service information (e.g., LADN DNN and/or service area information) to the selected at least one AMF. In this instance, the PCF does not directly manage the activation/deactivation of the LADN service and may delegate it to the AMF. If the PCF delegates the activation/deactivation of the LADN service to the AMF, period/time/cycle information in which the LADN service is provided and/or valid time information for the LADN information itself together with LADN service information may be transmitted to the AMF. Hereinafter, for convenience of explanation, period/time/cycle information in which the LADN service is provided and/or valid time information for the LADN information itself are referred to as ‘valid time information’.

The steps 2 and 3 described above may be performed on a per DNN basis not on a per UE/user basis.

4. The AMF may transmit updated LADN information (including DNN and/or updated service area information) to the UE/user subscribed/allowed to the LADN service. This figure illustrates that the updated LADN information is transmitted to the UE/user using a UE configuration update procedure, by way of example, but the present disclosure is not limited thereto. For example, it may be transmitted to the UE/user via various procedures/messages (e.g., registration accept message). Additionally, if the PCF delegates the activation/deactivation of the LADN service to the AMF (i.e., receives valid time information) in the step 3, the AMF may perform a validity check for the LADN service/information based on the valid time information received from the PCF. The AMF may transmit, to the UE, the valid time information received from the PCF together with the LADN information, to maintain consistency of information.

The UE may start/perform a procedure (i.e., step 5) that requests PDU session establishment/setup based on pre-configured LADN access allowance information and/or updated LADN information, without separate interaction with the user. Alternatively, the UE may provide/display, to the user, a popup window, that receives from the user an explicit allowance/reject input for actual access/service start, according to operator's configuration/policy. The explicit input may be received at an application layer through a LADN application provided for the LADN service provision. If the UE performs the explicit allowance input from the user, the UE may start/perform the step 5.

5. The UE performs a procedure for UE-initiated PDU session setup/establishment and setups/establishes a PDU session for LADN service. The LADN PDU session for the UE may be established/setup as a result of performing this step.

6-8. If the AMF decides that the UE is out of a LADN service area, the AMF may notify the SMF that the UE is out of the LADN service area. In this case, the SMF may decide/determine whether to release or deactivate a LADN PDU session. In the case of ‘release’ of the LADN PDU session, the network node deletes/removes all contexts of the corresponding LADN PDU session. On the other hand, in the case of ‘deactivation’, the network node does not delete/remove the contexts of the corresponding LADN PDU session and recognizes/records that the LADN PDU session is in a deactivation state. Thus, in the case of ‘deactivation’, when the UE enters again the LADN service area, the LADN PDU session that has been deactivated can be activated. However, it is impossible in the case of ‘release’.

The SMF may release or deactivate the LADN PDU session according to the decision/determination result, and notify the UE, via the AMF, that the LADN PDU session has been released or deactivated.

In the case of deactivation of the LADN PDU session, an explicit NAS message informing the release of PDU session may not be sent to the UE, and the AS layer of the UE may recognize only the release of a specific radio section resource. Thus, the NAS layer of the UE may be informed of an event about the specific radio section resource release from the AS layer and thus may impliedly recognize the temporary deactivation of LADN PDU session without the explicit NAS message.

However, the present disclosure is not limited thereto, and the following embodiments may be additionally present in relation to the LADN PDU session release/deactivation notification in the step 8.

### 1) Embodiment 1—Signalling with a NAS Cause Value (If the SMF Determines Releasing a LADN PDU Session)

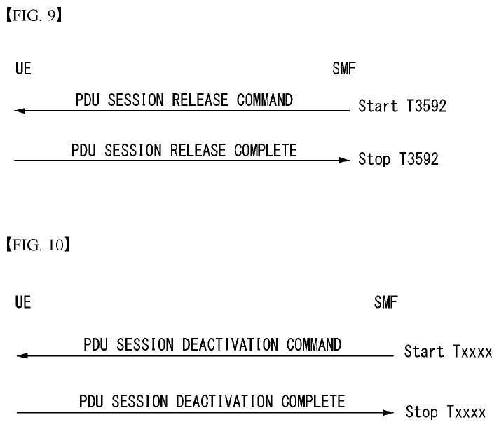

FIG. 9 illustrates an interaction between a UE and a SMF when the SMF determines releasing a LADN PDU session.

If the SMF determines releasing a LADN PDU session in the step 8 of FIG. 8, the SMF may create a SM NAS message (i.e., PDU session release command/message) informing the release of the (LADN) PDU session and may send it to the UE. In this instance, a release cause may be included in the corresponding SM NAS message, and examples of a session management (SM) cause value included as the release cause may be as follows.

#26: Insufficient resources;

#29: User authentication or authorization failed;

#36: Regular deactivation;

#39: Reactivation requested;

#67: Insufficient resources for specific slice and DNN;

#69: Insufficient resources for specific slice; and/or

#xx (any integer) LADN not allowed

That is, the existing defined SM cause value may be reused, or a new SM cause value (#xx) may be defined and used.

The SM cause value may be included as a SM cause information element (IE) of the SM NAS message informing the PDU session release and may be sent to the UE.

The SMF may encapsulate the SM NAS message in a N11 message and send it to the AMF, and the AMF may send the SM NAS message to the UE via a base station. If the release of PDU session is complete, the UE may respond to the SMF with the SM NAS message that informs that the PDU session release has been completed.

### 2) Embodiment 2—Signalling with a NAS Cause Value (By Defining a New NAS Message) (If the SMF Determines Deactivating a LADN PDU Session)

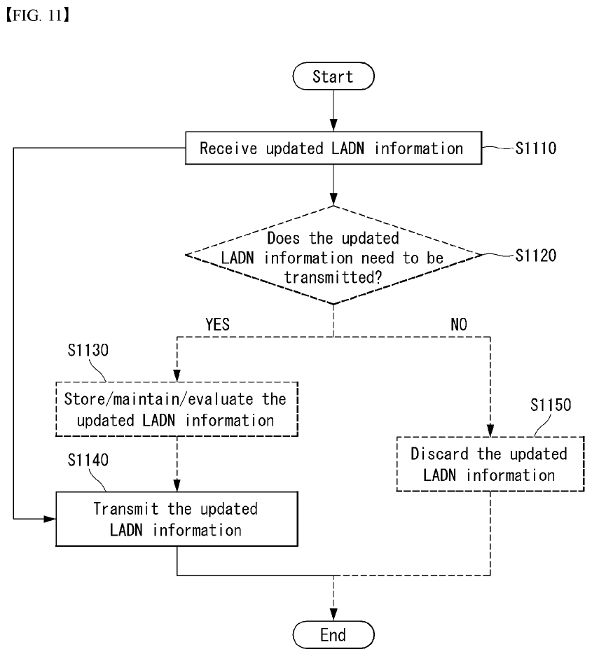

FIG. 10 illustrates an interaction between a UE and a SMF when the SMF determines deactivating a LADN PDU session.

If the SMF determines deactivating a LADN PDU session in the step 8 of FIG. 8, the SMF may create a SM NAS message (i.e., PDU session deactivation command/message) informing the deactivation of the (LADN) PDU session and may send it to the UE. In this instance, a deactivation cause may be included in the corresponding SM NAS message, and examples of a session management (SM) cause value included as the deactivation cause may be as follows.

#26: Insufficient resources;

#29: User authentication or authorization failed;

#36: Regular deactivation;

#39: Reactivation requested;

#67: Insufficient resources for specific slice and DNN;

#69: Insufficient resources for specific slice); and/or

#xx (any integer) LADN not allowed

That is, the existing defined SM cause value may be reused, or a new SM cause value (#xx) may be defined and used.

The SM cause value may be included as a SM cause information element (IE) of the SM NAS message informing the PDU session deactivation and may be sent to the UE.

The SMF may encapsulate the SM NAS message in a N11 message and send it to the AMF, and the AMF may send the SM NAS message to the UE via a base station. If the deactivation of PDU session is complete, the UE may respond to the SMF with the SM NAS message that informs that the PDU session deactivation has been completed.

### 3) Embodiment 3—Signalling with an AS Cause Value (If the SMF Determines Releasing or Deactivating a LADN PDU Session)

The SMF may include a separate indication for indicating/informing the release or deactivation of the LADN PDU session in the N11 message sent to the AMF. In this instance, the SMF may include a field capable of distinguishing a type of SM NAS in the N11 message and encapsulate the SM NAS message in the N11 message to send it to the AMF. The AMF may include the indication received from the SMF in a header of a message sent to the base station. This is to explicitly inform the base station of a cause requesting the release of radio resource.

The base station receiving the indication of the release or deactivation of the LADN PDU session may explicitly include, in a RRC message, detailed radio resource release cause information/value as in the following example and may send it to the UE:

Cause #xx: Resource release for LADN (PDU) session release (example)

Cause #xx: Resource release for LADN (PDU) session deactivation (example)

That is, the AS layer of the UE grasps a detailed cause for the release of the radio resource through the received cause value and sends it to the NAS layer.

As another embodiment, the AS cause value is not defined so that the AS layer explicitly grasps the meaning of the AS cause value, and may be defined as different cause values that are simply distinguished. In this case, if the AS layer of the UE receives two distinguished cause values although the AS layer does not know the meaning of the cause values, the AS layer may transparently send them to the upper NAS layer. The NAS layer distinguishes that the radio resource has been released for any cause according to pre-configured information based on the received cause value.

In the above-described embodiment illustrated in FIG. 8, the AMF may track a location of each UE on a per UE basis and update configuration information for each UE. In particular, the AMF may utilize a UE location checking method based on the interaction of NEF/UDM, and grasp the UE's location whose information shall be transmitted/updated. The serving AMF transmits LADN information that is updated according to the embodiment illustrated in FIG. 8 to the UE/user that is subscribed/allowed to a LADN service to be provided.

According to the embodiment of FIG. 8, since LADN service information of the UE is flexibly/dynamically updated in real time, there occurs an effect of more efficiently/accurately providing the LADN service to the UE/user.

FIG. 11 is a flow chart illustrating an LADN information updating method of the AMF according to an embodiment of the present disclosure. In relation to this flow chart, the embodiments and the descriptions described above can be equally/similarly applied to this flow chart, and a redundant description is omitted. In this embodiment, it is assumed that the UE previously receives, from the AMF, LADN information for a LADN service through a registration procedure or a UE configuration update procedure.

First, if an update occurs in LADN information for a LADN service configured for the UE, the AMF may receive the updated LADN information from a network node in S1110.

The updated LADN information may include information on an updated LADN service area and information on an updated LADN DNN. Next, the AMF may determine whether the updated LADN information needs to be transmitted to the UE in S1120. More specifically, the AMF may compare old LADN information, that has been stored/remembered, with newly received LADN information, and determine that the updated LADN information needs to be transmitted to the UE if they are different from each other. In this case, the AMF may perform steps S1130 and/or S1140. If they are the same as each other, the AMF may determine that the updated LADN information does not need to be transmitted to the UE, and perform step S1150.

If the AMF determines that the updated LADN information needs to be transmitted to the UE, the AMF may store/maintain/evaluate the updated LADN information in S1130. Next, the AMF may transmit the updated LADN information to the UE through the registration procedure or the UE configuration update procedure in S1140.

If the AMF determines that the updated LADN information does not need to be transmitted to the UE, the AMF may discard the updated LADN information in S1150.

In this flow chart, the AMF transmitting the updated LADN information to the UE may be determined based on the updated LADN service area. For example, the AMF located in the updated LADN service area may be selected. In this instance, the AMF may be selected by the PCF, and the updated LADN information may be transmitted to the AMF from the PCF.

The PCF may receive, from the NEF and/or the DN/AF, information on a provision area scope of the LADN service and/or information on a provision time of the LADN service. The PCF may select the AMF providing the updated LADN information considering the LADN service provision area scope and/or a serving AMF of the UE in addition to the updated LADN service area information.

In an embodiment, if the PCF additionally considers the LADN service provision area scope, the PCF may select the AMF located in the updated LADN service area and the LADN service provision area scope. In another embodiment, if the PCF additionally considers the serving AMF of the UE, the PCF may select the serving AMF and at least one AMF logically associated with the serving AMF.

The UE may establish a PDU session based on the updated LADN information, and may be provided with a LADN service via the established PDU session.

If the corresponding PDU session is released or deactivated, the UE may receive, from the SMF, information informing the release or deactivation of the established PDU session.

The information informing the release or deactivation of the established PDU session may be transmitted to the UE via a NAS message or a RRC message. Further, the information informing the release or deactivation of the established PDU session may contain cause information for the release or deactivation of the established PDU session.

In this flow chart, the steps S1120, S1130 and S1150 may be selectively performed according to an embodiment. For example, the step S1110 may be followed by the step S1140 according to an embodiment.

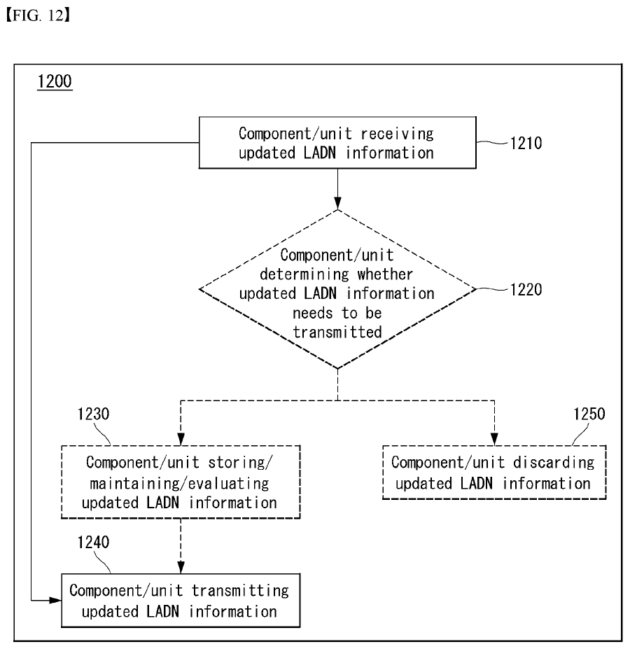

FIG. 12 is a block diagram of an AMF updating LADN information according to an embodiment of the present disclosure. In relation to this flow chart, the description of FIG. 11 can be equally/similarly applied to this flow chart, and a redundant description is omitted.

An AMF 1200 may include a component/unit 1210 receiving basically updated LADN information, and a component/unit 1240 transmitting updated LADN information. In addition, the AMF 1200 may further include a component/unit 1220 determining whether updated LADN information needs to be transmitted, a component/unit 1230 storing/maintaining/evaluating updated LADN information, and/or a component/unit 1250 discarding updated LADN information.

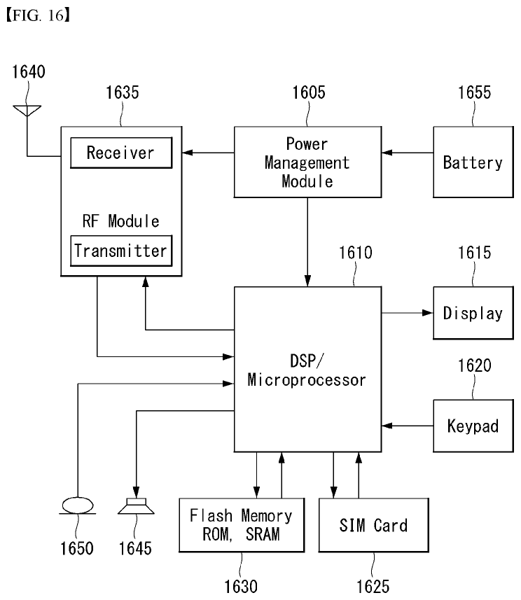

The components/units 1210 to 1250 of the AMF 1200 may be components/units configured to perform the steps S1110 to S1150 in the flow chart of FIG. 11, respectively. Each component/unit may consist of hardware component/part, and may correspond to a processor, a memory, and/or a communication module, or a combination thereof that are described below with reference to FIGS. 15 and 16.

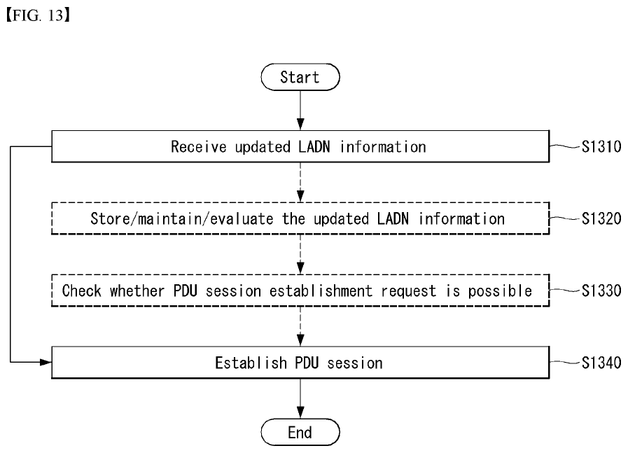

FIG. 13 is a flow chart illustrating an LADN information updating method of a UE according to an embodiment of the present disclosure. In relation to this flow chart, the embodiments and the descriptions described above can be equally/similarly applied to this flow chart, and a redundant description is omitted. In this embodiment, it is assumed that the UE previously receives, from the AMF, LADN information for a LADN service through a registration procedure or a UE configuration update procedure.

First, a UE may receive updated LADN information from an AMF in S1310. The updated LADN information may include information on an updated LADN service area and information on an updated LADN DNN. The updated LADN information may be transmitted to the UE through the registration procedure or the UE configuration update procedure.

Next, the UE may store/maintain/evaluate the LADN information received thus in S1320.

Next, the UE may check whether the current situation is a situation where a LADN PDU session can be requested to be established according to the related art before establishing a PDU session in S1330. For example, if a current location of the UE is out of an updated LADN service area, the UE can request the LADN PDU session establishment.

Next, the UE may establish the PDU session based on the updated LADN information to receive a LADN service in S1340.

The UE may be provided with the LADN service via the PDU session established thus.

If the corresponding PDU session is released or deactivated, the UE may receive, from the SMF, information informing the release or deactivation of the established PDU session.

The information informing the release or deactivation of the established PDU session may be transmitted to the UE via a NAS message or a RRC message. Further, the information informing the release or deactivation of the established PDU session may contain cause information for the release or deactivation of the established PDU session.

In this flow chart, the AMF transmitting the updated LADN information to the UE may be determined based on the updated LADN service area. For example, the AMF located in the updated LADN service area may be selected. In this instance, the AMF may be selected by the PCF, and the updated LADN information may be transmitted to the AMF from the PCF.

The PCF may receive, from the NEF and/or the DN/AF, provision area scope information of the LADN service and/or provision time information of the LADN service, and may select the AMF providing the updated LADN information considering a LADN service provision area scope and/or a serving AMF of the UE in addition to the updated LADN service area information.

In an embodiment, if the PCF additionally considers the LADN service provision area scope, the PCF may select the AMF located in the updated LADN service area and the LADN service provision area scope. In another embodiment, if the PCF additionally considers the serving AMF of the UE, the PCF may select the serving AMF and at least one AMF logically associated with the serving AMF.

In this flow chart, the steps S1320 and S1330 may be omitted or selectively performed according to an embodiment. For example, the step S1310 may be followed by the step S1340.

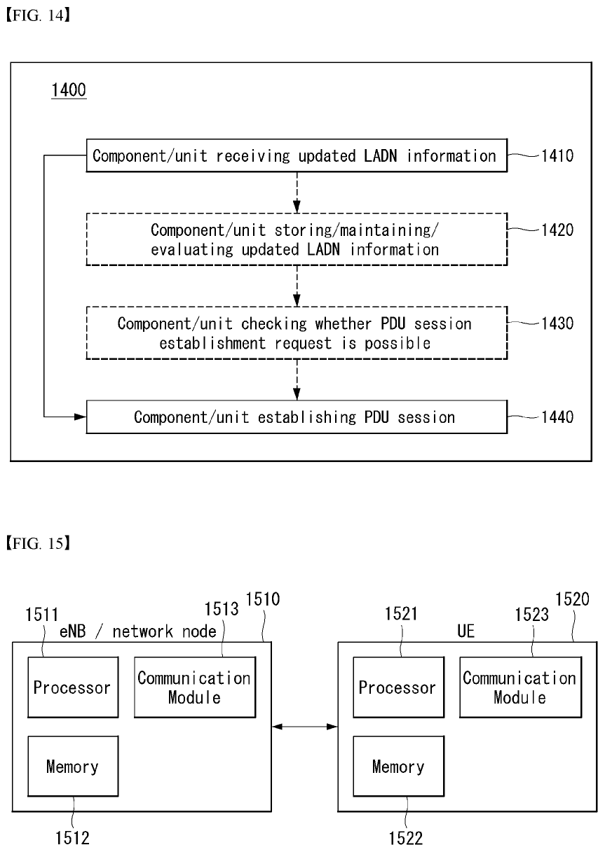

FIG. 14 is a block diagram of a UE updating LADN information according to an embodiment of the present disclosure. In relation to this flow chart, the description of FIG. 13 can be equally/similarly applied to this flow chart, and a redundant description is omitted.

A UE 1400 may include a component/unit 1410 receiving basically updated LADN information, and a component/unit 1440 establishing a PDU session. In addition, the UE 1400 may further include a component/unit 1420 storing/maintaining/evaluating updated LADN information, and/or a component/unit 1430 checking whether PDU session establishment request is possible.

The components/units 1410 to 1440 of the UE 1400 may be components/units configured to perform the steps S1310 to S1340 in the flow chart of FIG. 13, respectively. Each component/unit may consist of hardware component/part, and may correspond to a processor, a memory, and/or a communication module, or a combination thereof that are described below with reference to FIGS. 15 and 16.

### Overview of Device to which the Present Disclosure is Applicable

FIG. 15 illustrates a block configuration diagram of a communication device according to an embodiment of the present disclosure.

Referring to FIG. 15, a wireless communication system includes a network node 1510 and a plurality of UEs 1520.

The network node 1510 includes a processor 1511, a memory 1512, and a communication module 1513. The processor 1511 may implement functions, processes, embodiments and/or methods described above, and may be described by being identified with the network node 1510 for convenience of explanation in the present disclosure. Layers of wired/wireless interface protocol may be implemented by the processor 1511. The memory 1512 is connected to the processor 1511 and stores various types of information for driving the processor 1511. The communication module 1513 is connected to the processor 1511 and transmits and/or receives wired/wireless signals. An example of the network node 1510 may correspond to a base station, MME, HSS, SGW, PGW, an application server, or the like. In particular, if the network node 1510 is the base station, the communication module 1513 may include a radio frequency (RF) unit for transmitting/receiving a radio signal.

The UE 1520 includes a processor 1521, a memory 1522, and a communication module (or RF unit) 1523. The processor 1521 may implement functions, processes, embodiments and/or methods described above, and may be described by being identified with the UE 1520 for convenience of explanation in the present disclosure. Layers of a radio interface protocol may be implemented by the processor 1521. The memory 1522 is connected to the processor 1521 and stores various types of information for driving the processor 1521. The communication module 1523 is connected to the processor 1521 and transmits and/or receives a radio signal.

The memories 1512 and 1522 may be inside or outside the processors 1511 and 1521 and may be connected to the processors 1511 and 1521 through various well-known means. Further, the network node 1510 (in case of the base station) and/or the UE 1520 may have a single antenna or multiple antennas.

FIG. 16 illustrates a block configuration diagram of a communication device according to an embodiment of the present disclosure.

In particular, FIG. 16 illustrates in more detail the UE illustrated in FIG. 15.

Referring to FIG. 16, the UE may include a processor (or digital signal processor (DSP)) 1610, an RF module (or RF unit) 1635, a power management module 1605, an antenna 1640, a battery 1655, a display 1615, a keypad 1620, a memory 1630, a subscriber identification module (SIM) card 1625 (which is optional), a speaker 1645, and a microphone 1650. The UE may also include a single antenna or multiple antennas.

The processor 1610 implements functions, processes, and/or methods described above. Layers of a radio interface protocol may be implemented by the processor 1610.

The memory 1630 is connected to the processor 1610 and stores information related to operations of the processor 1610. The memory 1630 may be inside or outside the processor 1610 and may be connected to the processors 1610 through various well-known means.

A user inputs instructional information, such as a telephone number, for example, by pushing (or touching) buttons of the keypad 1620 or by voice activation using the microphone 1650. The processor 1610 receives and processes the instructional information to perform an appropriate function, such as to dial the telephone number. Operational data may be extracted from the SIM card 1625 or the memory 1630. Further, the processor 1610 may display instructional information or operational information on the display 1615 for the user's reference and convenience.

The RF module 1635 is connected to the processor 1610 and transmits and/or receives an RF signal. The processor 1610 forwards instructional information to the RF module 1635 in order to initiate communication, for example, transmit a radio signal configuring voice communication data. The RF module 1635 includes a receiver and a transmitter to receive and transmit the radio signal. The antenna 1640 functions to transmit and receive the radio signal. Upon reception of the radio signal, the RF module 1635 may send a signal to be processed by the processor 1610 and convert the signal into a baseband. The processed signal may be converted into audible or readable information output via the speaker 1645.

The aforementioned embodiments are achieved by combination of structural elements and features of the present disclosure in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present disclosure. The order of operations described in the embodiments of the present disclosure may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments of the present disclosure may be achieved by various means, for example, hardware, firmware, software, or a combination thereof. In a hardware configuration, the methods according to the embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present disclosure may be implemented in the form of a module, a procedure, a function, etc. Software code may be stored in a memory unit and executed by a processor. The memory unit may be located at the interior or exterior of the processor and may transmit data to and receive data from the processor via various known means.

In the present disclosure, ‘A and/or B’ may mean at least one of A and/or B.

It will be apparent to those skilled in the art that various modifications and variations can be made in the present disclosure without departing from the spirit or scope of the disclosure. Thus, it is intended that the present disclosure covers the modifications and variations of the present disclosure provided they come within the scope of the appended claims and their equivalents.

### INDUSTRIAL APPLICABILITY

The present disclosure has been described focusing on examples applying to the 3GPP LTE/LTE-A(5G) system, but can be applied to various wireless communication systems other than the 3GPP LTE/LTE-A(5G) system.

1. A method for updating local access data network (LADN) information by an access and mobility management function (AMF) in a wireless communication system, the method comprising:
based on an update occurring in the LADN information for a LADN service configured for a user equipment (UE), receiving the updated LADN information, the updated LADN information including information on an updated LADN service area and information on an updated LADN data network name (DNN); and
transmitting the updated LADN information to the UE,
wherein the AMF is determined based on the updated LADN service area.

2. The method of claim 1, wherein the updated LADN information is transmitted to the UE through a registration procedure or a UE configuration update procedure.

3. The method of claim 2, wherein as the AMF, an AMF located in the updated LADN service area is selected.

4. The method of claim 3, wherein the AMF is selected by a policy control function (PCF),
wherein the updated LADN information is received from the PCF.

5. The method of claim 4, wherein the PCF is a network node that receives, from a network exposure function (NEF) and/or a data network (DN)/application function (AF), information on a provision area scope of the LADN service and/or information on a provision time of the LADN service.

6. The method of claim 5, wherein the AMF is selected considering the LADN service provision area scope and/or a serving AMF of the UE, in addition to the updated LADN service area information.

7. The method of claim 5, wherein based on the LADN service provision area scope being additionally considered, as the AMF, an AMF located in the updated LADN service area and the LADN service provision area scope is selected.

8. The method of claim 5, wherein based on a serving AMF of the UE being additionally considered, as the AMF, the serving AMF and at least one AMF logically associated with the serving AMF are selected.

9. The method of claim 3, wherein the UE establishes a packet data unit (PDU) session based on the updated LADN information, and is provided with the LADN service via the established PDU session.

10. The method of claim 9, further comprising:
receiving, from a session management function (SMF), information informing a release or a deactivation of the established PDU session to transmit the information to the UE.

11. The method of claim 10, wherein the information informing the release or the deactivation of the established PDU session is transmitted to the UE via a non-access stratum (NAS) message or a radio resource control (RRC) message.

12. The method of claim 11, wherein the information informing the release or the deactivation of the established PDU session includes cause information for the release or the deactivation of the established PDU session.

13. The method of claim 1, wherein transmitting the updated LADN information to the UE is performed based on a determination that the received updated LADN information is compared with and different from LADN information that has been already stored for the UE.

14. An access and mobility management function (AMF) updating local access data network (LADN) information in a wireless communication system, the AMF comprising:
a communication module configured to transmit and receive a signal; and
a processor configured to control the communication module,
wherein the processor is configured to:
based on an update occurring in the LADN information for a LADN service configured for a user equipment (UE), receive the updated LADN information from a network node, the updated LADN information including information on an updated LADN service area and information on an updated LADN data network name (DNN); and
transmit the updated LADN information to the UE,
wherein the AMF is determined based on the updated LADN service area.

15. A user equipment (UE) updating local access data network (LADN) information in a wireless communication system, the UE comprising:
a display;
a communication module configured to transmit and receive a signal; and
a processor configured to control the display, and the communication module,
wherein the processor is configured to:
receive updated LADN information from an access and mobility management function (AMF), the updated LADN information including information on an updated LADN service area and information on an updated LADN data network name (DNN); and
establish a packet data unit (PDU) session based on the updated LADN information to receive a LADN service for the UE,
wherein the AMF is determined based on the updated LADN service area.

16. The UE of claim 15, wherein the processor is configured to:
display, via the display, a popup window for allowance or reject the LADN service start; and
receive, from a user, via the popup window, an input value for allowance the LADN service start;
wherein the establishing for the PDU session is triggered, based on the input value.

17. The UE of claim 16,
wherein the input value is received on an application layer related with an application provided for the LADN service provision.
